(19) United States
(12) Patent Application Publication
(10) Pub. No.: US 2002/0103598 A1
(43) Pub. Date: Aug. 1, 2002

(54) Contents replay system

(75) Inventor: Nobuya Nakamoto, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO MINATO-KU (JP)

(21) Appl. No.: 10/058,987

(22) Filed: Jan. 30, 2002

(30) Foreign Application Priority Data
Jan. 30, 2001 (JP) 2001-021595

(51) Int. Cl. G01C 21/26

(52) U.S. Cl. 701/207; 340/988

(57) ABSTRACT

An object of the present invention is to provide a contents replay system capable of replaying desired contents at a specified place. The contents replay system includes a registration unit which registers location information indicating a specific location and contents information indicating contents to be replayed at the specific location designated by a user, a detection unit which detects that the contents replay system is currently located at the specific location and a replay unit which replay the contents at the specific location detected by the detection unit.

### BACKGROUND OF THE INVENTION

The present invention relates to a contents replay system for replay contents such as music or the like at a moving terminal such as a car navigation system.

When driving a car, it is usual to enjoy the driving while listening to music or the like using a car audio and the like installed in the car. It can be fully enjoyable to have the music on while driving, when the music suitable for a scenery or a situation of an environment is selected. As described above, in a conventional driving, even if a music constitution such as the order of music is carefully planned, there was a problem that the timing to play the music did not fit to the timing of the initial plan due to traffic conditions and the like of the driving course which change from moment to moment, thereby reducing the degree of full enjoyment of driving by half.

### SUMMARY OF THE INVENTION

An object of the present invention is to provide a contents replay system capable of replaying desired contents to be replayed at a specified place.

According to the present invention, a contents replay system includes a registration unit which registers location information indicating a specific location and contents information indicating contents to be replayed at the specific location designated by a user, a detection unit which detects that the contents replay system is currently located at the specific location and a replay unit which replay the contents at the specific location detected by the detection unit.

### BRIEF DESCRIPTION OF THE DRAWINGS

These and other objects, features and advantages of the invention will become more apparent from the following detailed description when taken in conjunction with the accompanying drawings, in which:

FIG. 1 is a block diagram showing a constitution of a car navigation system 100 of a first embodiment of the present invention;

FIG. 2 is a block diagram showing a functional constitution of the car navigation system 100 of first embodiment of the present invention;

FIG. 3 is a flowchart for explaining the processing of the car navigation system 100 according to a first embodiment of the present invention;

FIG. 4 is a block diagram showing a constitution of a contents replay system of a second embodiment of the present invention;

FIG. 5 is a block diagram showing a constitution of a contents providing server 200 of the second embodiment of the present invention;

FIG. 6 is a block diagram showing a functional constitution of the contents providing server 200;

FIG. 7 is a flow chart for explaining a communication between the car navigation system 100 and contents providing server 200;

FIG. 8 is a flow chart for explaining a communication between the car navigation system 100 and contents providing server 200;

FIG. 9 is a flow chart for explaining a communication between the car navigation system 100 and contents providing server 200;

FIG. 10 is a block diagram showing a constitution of a contents replay system of a third embodiment of the present invention;

FIG. 11 is a block diagram showing a constitution of a user terminal 300 of the third embodiment of the present invention;

FIG. 12 is a block diagram showing a functional constitution of the user terminal 300;

FIG. 13 is a flow chart for explaining a communication between the user terminal 300 and contents providing server 200;

FIG. 14 is a flow chart for explaining a communication between the car navigation system 100 and the contents providing server 200;

FIG. 15 is a flow chart for explaining a communication between the user terminal 300 and the contents providing server 200;

FIG. 16 is a flow chart for explaining a communication between the user terminal 300 and the contents providing server 200; and

FIG. 17 is a flow chart for explaining a communication between the user terminal 300 and the contents providing server 200.

In the drawings, the same reference numerals represent the same structural elements.

### DESCRIPTION OF THE PREFERRED EMBODIMENTS

Next, the present invention will be explained in detail below in reference to the accompanying drawings.

A contents replay system of a first embodiment of the present invention is composed by a car navigation system descried below.

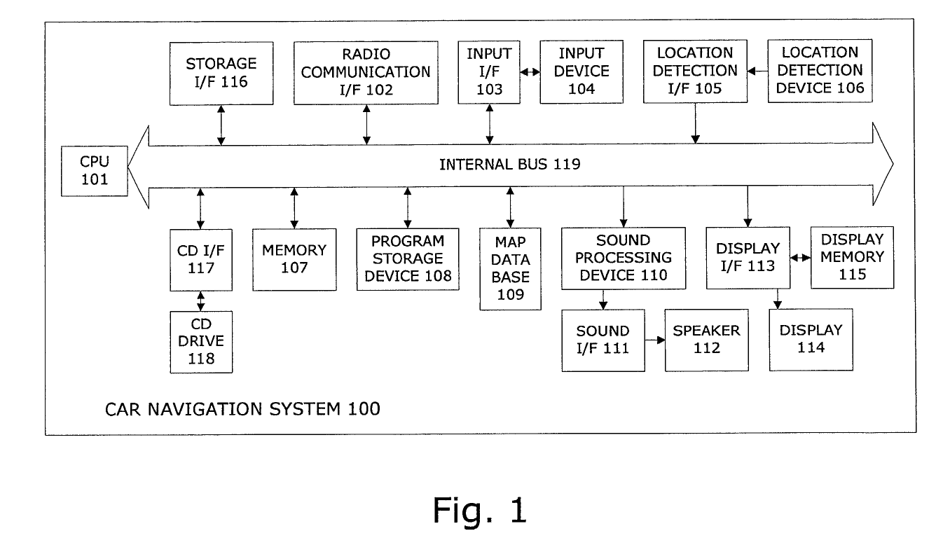

Referring to FIG. 1, the car navigation system 100 to be installed on a car includes a CPU 101, a radio communication I/F 102, an input I/F 103, an input device 104 such as a remote control device, a touch panel, a keyboard or a mouse, a location detection I/F 105, a location detection device 106 for detecting a location of the car navigation system 100 by using a Global Positioning System (GPS), a memory 107, a program storage device 108, a map database 109, a sound processing device 110, a sound I/F 111, a speaker 112, a display I/F 113, a display memory 114, a display 115, a storage I/F 116 for a removable storage such as a memory card, a compact disk (CD) I/F 117, a CD drive 118 and an internal bus 119.

The CPU 101, the location detection I/F 105, the input I/F 103, the memory 107, the program storage device 108, the map database 109, the sound processing device 110, the display I/F 113, the storage I/F 116, and the CD I/F 117 are connected to the internal bus 119.

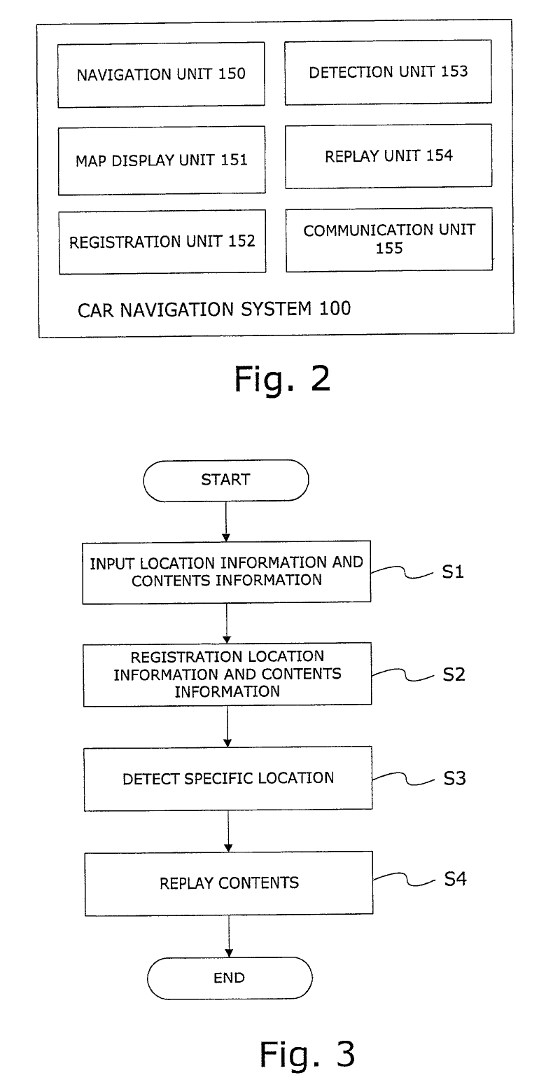

The CPU 101 executes program stored in the program storage device 108 and controls the car navigation system 100. From the stand point of the program, the car navigation system 100 has following functional units. Referring to FIG. 2, the car navigation system 100 has a navigation unit 150, a map display unit 151, a registration unit 152, a detection unit 153, a replay unit 154 and a communication unit 155.

The navigation unit 150 executes a standard car navigation function, for example, to navigate a driver to a destination by using the location detection device 116 and to indicate the present location to the driver. The map display unit 151 displays maps such as a present location map and the destination map on the display 115 by referring to the map database 109.

Next, the operation of the car navigation system 100 will be described in detail.

Referring to FIG. 3, a user inputs location information indicating specific location, for example, an interim destination or a destination, by pointing to a map displayed on the display 115 by input device 104. Further, the user chooses contents, which the user wants to be replayed at the specific location, and inputs contents information, for example, a file name of the contents (Step S1). The contents, for example, music or video is stored in a CD installed in the CD drive 118, a removable medium connected to the storage I/F 116 or a car stereo connected to the sound I/F 111.

Then, the registration unit 152 relates the location information with the contents information and stores them in the memory 107 (Step S2). Above operations are performed before a departure.

After a while, based on the location information, the detection unit 153 detects the present location is the specific location by using the location detection device 106 (Step S3). Then, the replay unit 154 replays the contents corresponding to the specific location by using the speaker 112 and the display 115 (Step S4).

Next, a contents replay system of a second embodiment of the present invention will be explained in detail.

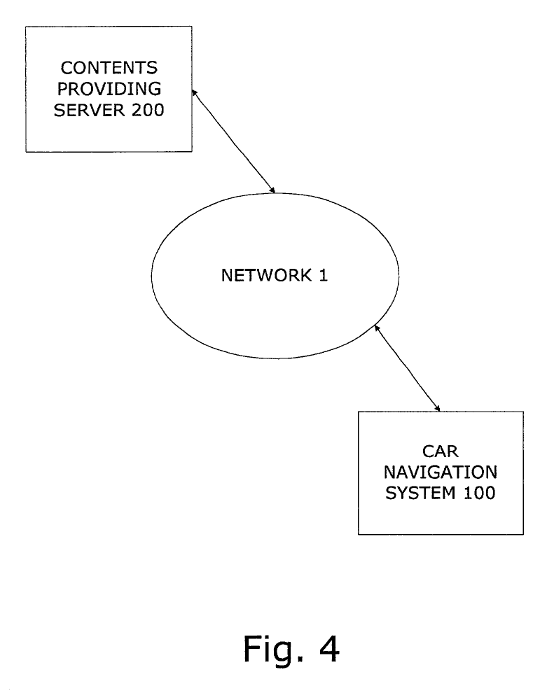

Referring to FIG. 4, a contents replay system of a second embodiment of the present invention includes a network 1 such as the Internet, the car navigation system 100 and a contents providing server 200. The car navigation system 100 is connected to the contents providing server 200 via the network 1.

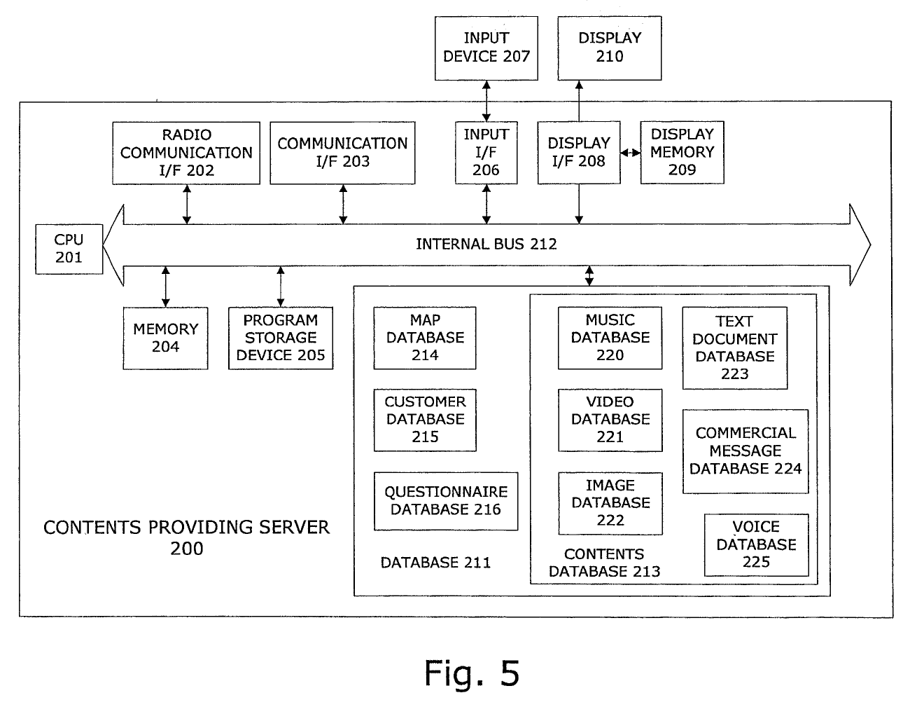

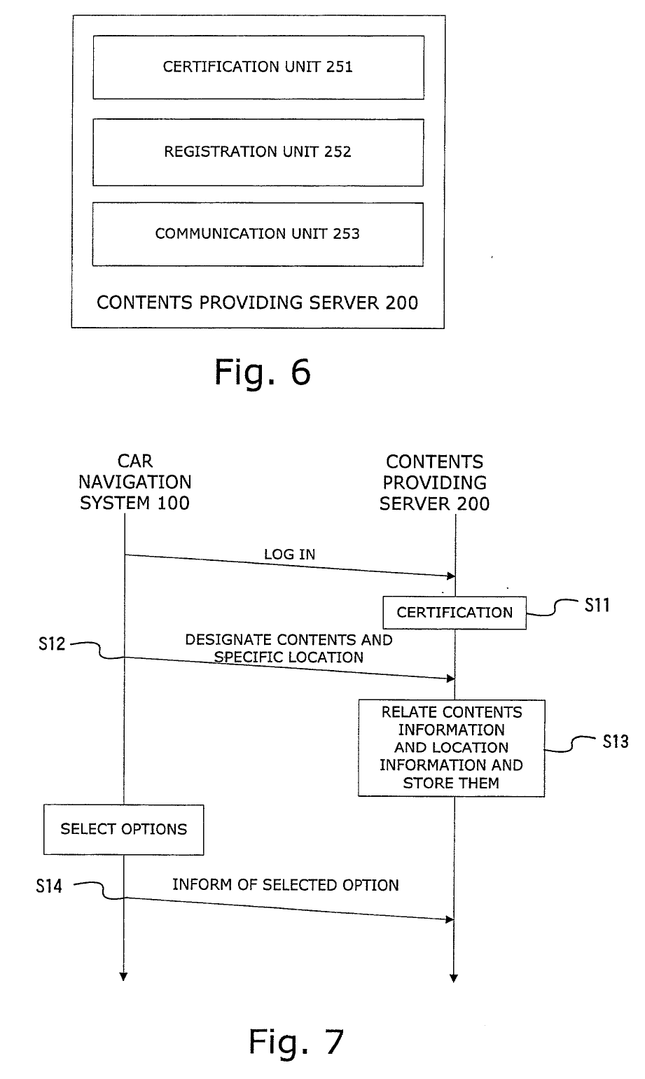

Referring to FIG. 5, the contents providing server 200 includes a CPU 201, a radio communication I/F 202 connectable to the network 1, a communication I/F 203 connectable to the network 1, a memory 204, a program storage device 205, an input I/F 206 connectable to an input device 207 such as a keyboard and a mouse, a display I/F 208 connectable to a display 210, a display memory 209, a database 211 and an internal bus 212. The database 211 includes a contents database 213, a map database 214 and a customer database 215, a questionnaire database 216. The contents database 213 includes a music database 220, a video database 221, an image database 222, a text document database 223, a commercial message database 224 and a voice database 225. In commercial message database 224, as the data thereof flows, commercial message which are music, image and text data and the like where a commercial effect of certain commodity and service and the like generates are stored. Voice data in the voice database 225 is used for the so-called voice memo function. Therefore, a user can store the voice data in the voice data anytime.

The CPU 201, the radio communication I/F 202, the communication I/F 203, the memory 204, the program storage device 205, the input I/F 206, the display I/F 208 and the data base 211 are connected to the internal bus 212.

The CPU 201 executes program stored in the program storage device 205 and controls the contents providing server 200. From the stand point of the program, the contents providing server 200 has following functional units. Referring to FIG. 7, the contents providing server 200 has a certification unit 251, a registration unit 252 and a communication unit 253.

Next, the operation of the contents replay system of the second embodiment of the present invention will be described in detail. Firstly, there are two kinds of ways of replaying contents, which can be selected by user operating the car navigation system 100.

The first way is the same as the way according to the first embodiment of the present invention described above.

In the second way, referring to FIG. 7, the communication unit 155 of the car navigation system 100 transfers a user ID and a password inputted by a user or prepared in the system 100 in advance to the contents providing server 200 via the network 1. Then, certification unit 251 of the contents providing server 200 receives the user ID and the password and certifies the user by referring to the customer data base 215. Namely, the car navigation system 100 logs in the contents providing server 200 (Step S11).

Then, the user designates a specific location by referring to the map database 109 of the car navigation system 100 or the map database 214 of the contents providing server 200. Further, the user chooses and designates contents by referring to the contents database 213 via the network 1. The user refers the contents database 213 by using a selection screen transmitted from the contents providing server 200 and displayed on the car navigation system 100 (Step S12). This operation is performed by the communication unit 155 of the car navigation system 100.

Then, the registration unit 252 of the contents providing server 200 relates the information of the chosen contents and location information indicating the specific location and stores them in a record corresponding to the user ID in the customer data base 215 of the contents providing server 200 (Step S13).

Here, the user chooses one of two options by referring to a selection screen. Then, the communication unit 155 of the car navigation system 100 informs the contents providing server 200 of information on the selected option. Then, the communication unit 253 of the contents providing server 200 receives it (Step S14).

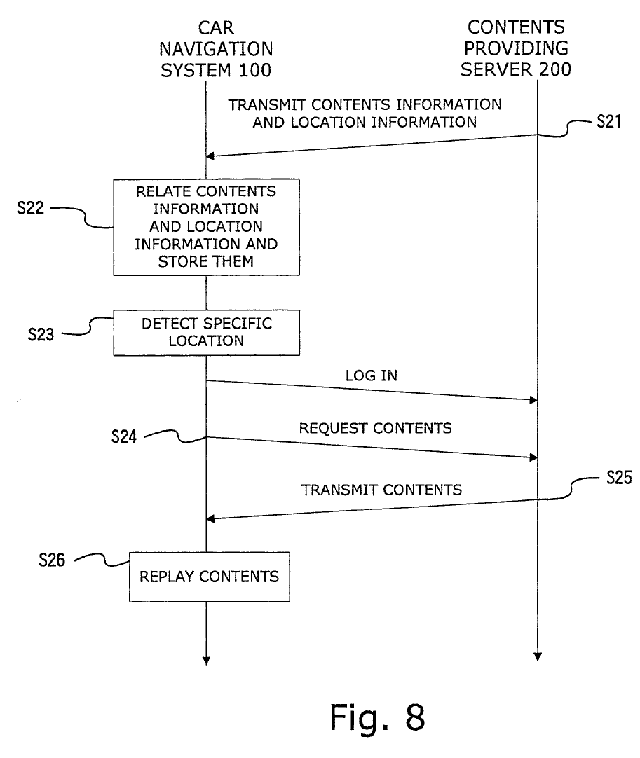

In case that the user chooses a first option in the step S14, referring to FIG. 8, the communication unit 253 of the contents providing server 200 transmits the information of the chosen contents and the location information to the car navigation system 100 via the network 1 (Step S21).

Then, the communication unit 155 of the car navigation system 100 receives the information. Then, the registration unit 152 of the car navigation system 100 relates the information on the chosen contents (for example, a file name of the contents) with the location information and stores them in the memory 107 of the car navigation system 100 (Step S22). Then, the contents providing server 200 disconnects a connection with the car navigation system 100. The above operation is performed before a departure.

After a while, when a car in which the car navigation system 100 is installed arrives at the specific location, the detection unit 153 of the car navigation system 100 detects that the present location is the specific location based on the location information (Step S23). Then, the communication unit 155 of the car navigation system 100 logs in the contents providing server 200 automatically. Then, based on the information of the contents stored in advance, the communication unit 155 requests the contents providing server 200 to transmit the contents corresponding to the specific location, which is registered in advance, via the network 1 (Step S24).

The communication unit 253 of the contents providing server 200 receives the request, and then, in response to the request, the communication unit 253 transmits the contents to the car navigation system 100 via the network 1 by referring to the customer data base 215 (Step S25).

Then, the replay unit 154 of the car navigation system 100 replays the contents (Step S26).

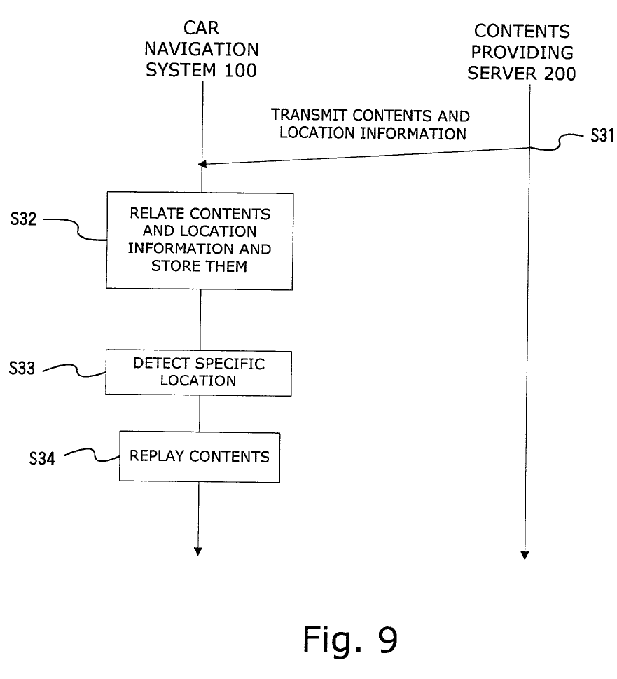

On the other hand, in case that the user chooses a second option in step S14, referring to FIG. 9, the communication unit 253 of the contents providing server 200 transmits the chosen contents to the car navigation system 100 (Step S31).

Then, the communication unit 155 of the car navigation system 100 receives the contents and the location information. Then, the registration unit 152 of the car navigation system 100 relates the chosen contents with the location information and stores them in the memory 107 of the car navigation system 100 (Step S32). Then, the contents providing server 200 disconnects a connection with the car navigation system 100. These operations are also performed before the departure.

After a while, when a car arrives at the specific location, the detection unit 153 of the car navigation system detects that the present location is the specific location (Step S33). Then, the replay unit 154 of the car navigation system 100 replays the contents corresponding to the specific location, which is stored in the car navigation system in advance (Step S34).

Next, a contents replay system of a third embodiment of the present invention will be explained in detail.

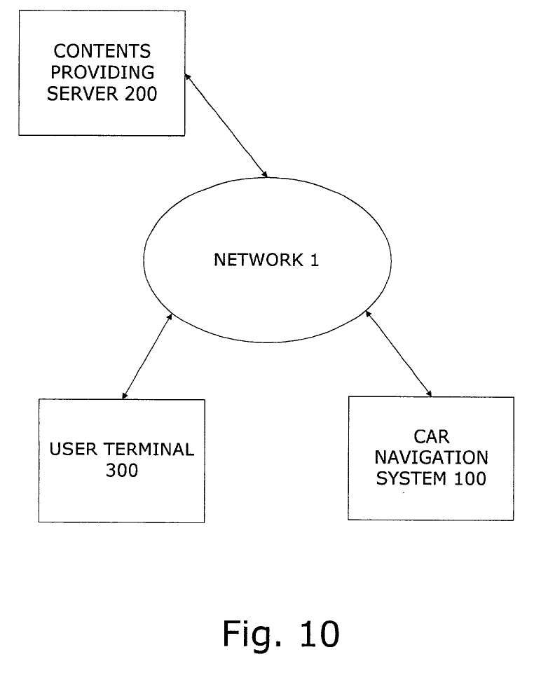

Referring to FIG. 10, a contents replay system of the third embodiment of the present invention includes the network 1, the car navigation system 100, the contents providing server 200 and a user terminal 300. The car navigation system 100 and the user terminal 300 are connected to the contents providing server 200 via the network 1.

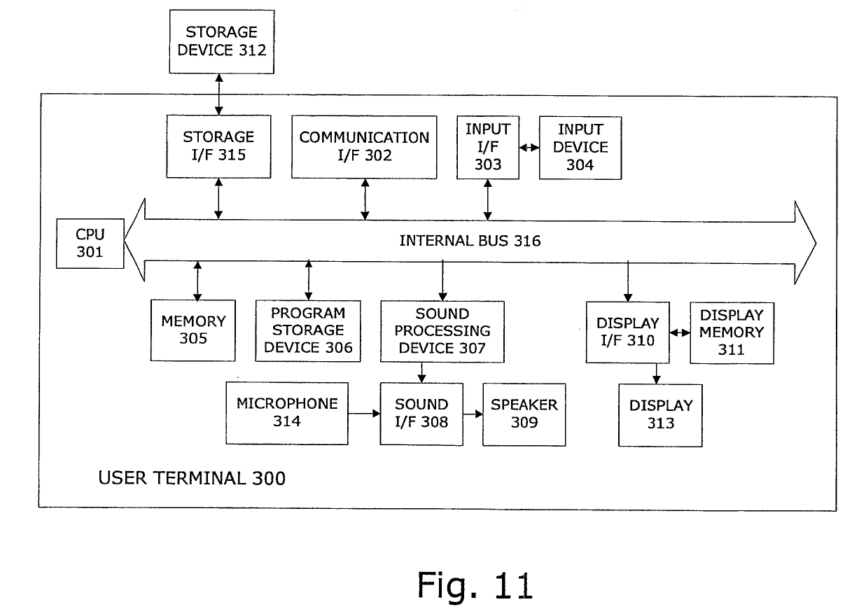

Referring to FIG. 11, the user terminal 300 includes a CPU 301, a communication I/F 302 for connecting to the network 1, an input I/F 303, an input device 304 such as a keyboard and a mouse, a memory 305, a program storage device 306, a sound processing device 307, a sound I/F 308, a speaker 309, a display I/F 310, a display memory 311, a display 313, a microphone 314, a storage I/F 315 for connecting to a removable storage device 312 and an internal bus 316.

The CPU 301, the communication I/F 302, the input I/F 303, the memory 305, the program storage device 306, the sound processing device 307, the display I/F 310, and the storage I/F 315 are connected to the internal bus 316. The CPU 301 executes program stored in the program storage device 306 and controls the user terminal 300.

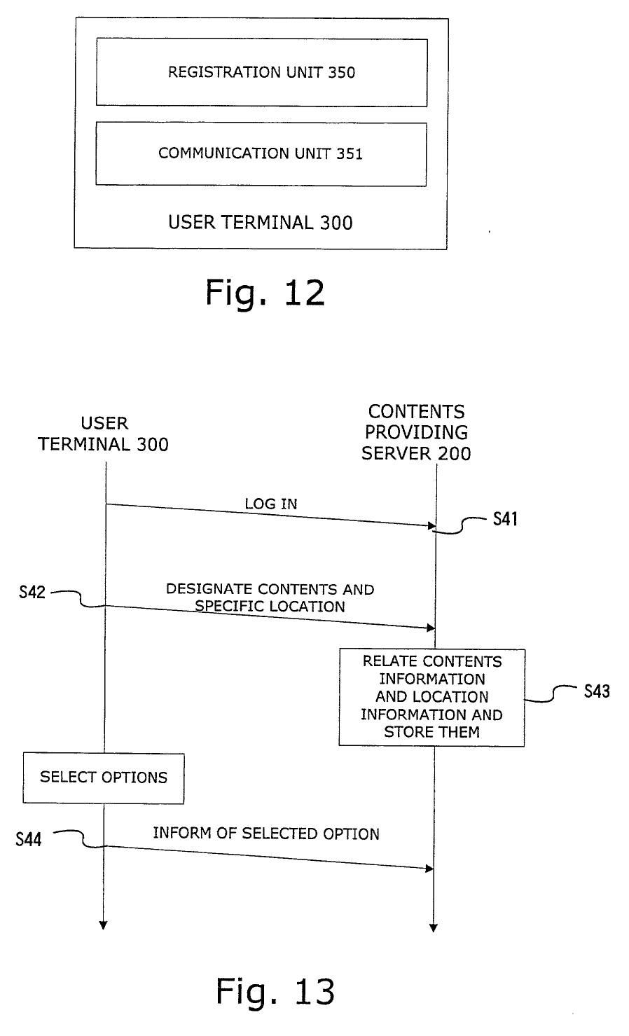

From the stand point of the program stored in the program storage device 308, the user terminal 300 has following functional units. Referring to FIG. 12, the user terminal 300 has a registration unit 350 and a communication unit 351.

Next, the operation of the contents replay system of the third embodiment of the present invention will be described in detail. Firstly, there are three kinds of ways of replaying contents, which are selectable by a user.

The first and the second way are the same way as the way according to the second embodiment of the present invention described above.

Next, in the third way, referring to FIG. 13, the communication unit 351 of the user terminal 300 logs in the contents providing server 200 by a user's operation (Step S41). Then, the user designates a specific location by referring to the map database 214 of the contents providing server 200. Further, the user chooses and designates contents by referring to the contents database 213 via the network 1 (Step S42). This operation is performed by the communication unit 351 of the user terminal 300.

Then, the registration unit 252 of the contents providing server 200 relates the information of the chosen contents and location information indicating the specific location and stores them in a record corresponding to the user ID in the customer data base 215 of the contents providing server 200 (Step S43).

Here, the user chooses one of two options. Then, the communication unit 351 of the user terminal 300 informs the contents providing server 200 of the selected option. Then, the communication unit 253 of the contents providing server 200 receives it (Step S44).

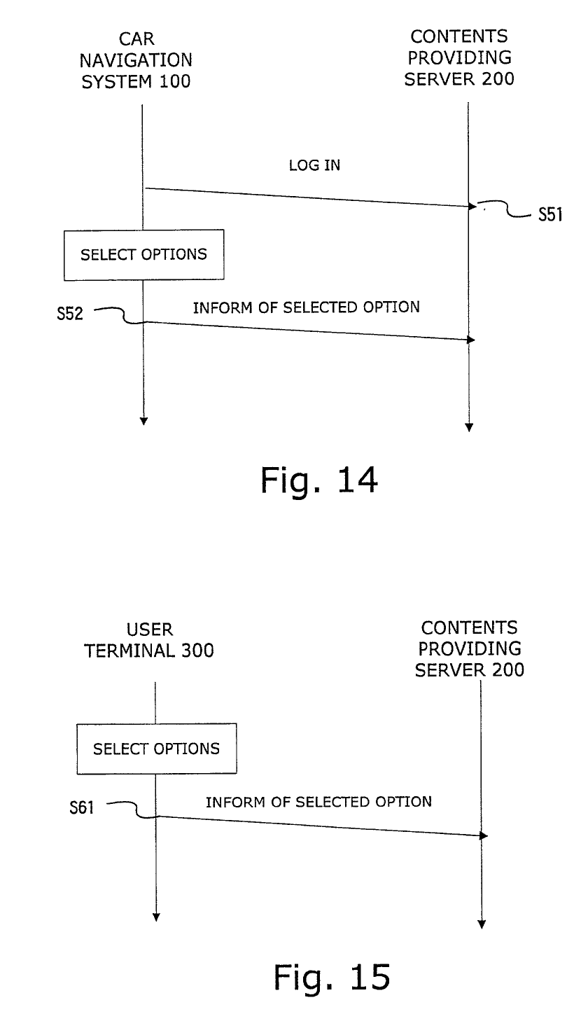

In case that the user chooses a first option in the step S44, referring to FIG. 14, the contents providing server 200 disconnects a connection with the user terminal 300. The above operation is performed before a departure, for example, at user's home.

Then, the user gets on the car and operates the car navigation system 100. Under the user's operation, the communication unit 155 of the car navigation system 100 logs in the contents providing server 200 (Step S51).

Here, further, the user chooses one of two options. Then, the communication unit 155 of the car navigation system 100 informs the contents providing server 200 of the selected option. Then, the communication unit 253 of the contents providing server 200 receives it (Step S52).

In the step S52, in case that the user chooses a first option, processes of replaying the contents by the car navigation system 100 and the contents providing system 200 are same as the processes explained in FIG. 8. On the other hand, in case that the user chooses a second option in the step S53, processes of replaying the contents by the car navigation system 100 and the contents providing system 200 are same as the processes explained in FIG. 9.

Next, in the step S44 of FIG. 13, in case that the user chooses a second option, referring to FIG. 15, the user further selects one of two options. Then, the communication unit 351 of the user terminal 300 informs the contents providing server 200 of the selected option. Then, the communication unit 253 of the contents providing server 200 receives it (Step S61).

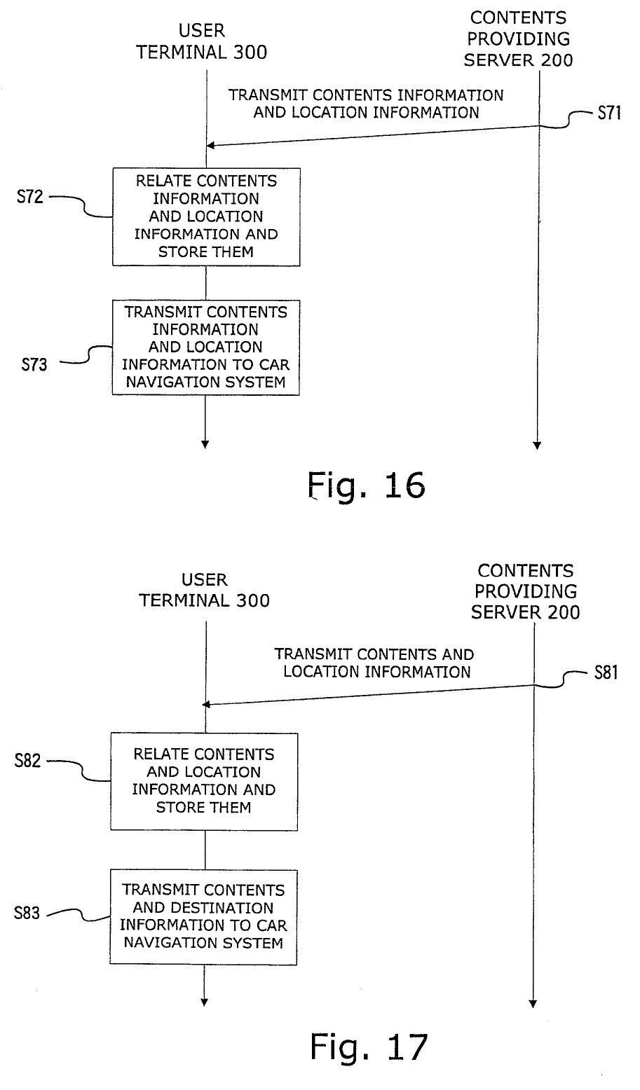

In case that the user chooses a first option in the step S61, referring to FIG. 16, the communication unit 253 of the contents providing server 200 transmits the information of the chosen contents and the location information to the user terminal 300 via the network 1 (Step S71).

Then, the communication unit 351 of the user terminal 300 receives the information. Then, the registration unit 350 of the user terminal 300 relates the information of the chosen contents with the location information and stores them in the removable storage device 312 (Step S72). Then, the contents providing server 200 disconnects a connection with the user terminal 300.

Then, the user installs the removable storage device 312 in the car navigation system 100 (Step S73). Here, the information stored in the removable storage device 312 may be transmitted to the car navigation system 100 by a radio communication between them. The above operations are performed before a departure.

After the step S73, processes of replaying the contents by the car navigation system 100 and the contents providing system 200 are same as the processes of the step S23 through the step 26 explained in FIG. 8.

On the other hand, in case that the user chooses a second option in the step S61, referring to FIG. 17,the communication unit 253 of the contents providing server 200 transmits the chosen contents and the location information to the user terminal 300 via the network 1 (Step S81).

Then, the communication unit 351 of the user terminal 300 receives the contents and the information. Then, the registration unit 350 of the user terminal 300 relates the chosen contents with the location information and stores them in the removable storage device 312 (Step S82). Then, the contents providing server 200 disconnects a connection with the user terminal 300.

Then, the user installs the removable storage device 312 in the car navigation system 100 (Step S83). Here, the information stored in the removable storage device 312 may also be transmitted to the car navigation system 100 by a radio communication between them. The above operations are performed before a departure.

After the step S73, processes of replaying the contents by the car navigation system 100 and the contents providing system 200 are same as the processes of the step S33 through the step 34 explained in FIG. 9.

As described above, in the contents replay system of these embodiments of the present invention, when the user arrived at the place where the user desires to replay the contents, the user can obtain the contents without making manual setting.

In the above described embodiments, the user may replay desired contents manually, until the user arrives at a destination. Further, there may be more than one specific location.

Further, the contents providing server 200, every time one contents is supplied at a time, imposes a charge on the user as the service charge. Information of the charge is registered in the customer database 215. However, in such a case where the user downloads the contents in the commercial message database 224, in view of the commercial effect thereof, the user is reduced of the service charge.

Then, after the service for providing the contents is completed, the contents providing server 200 sends out questionnaire to the car navigation system 100 or the user terminal 300 to obtain information about the contents, after the user filled out the questionnaire, the contents providing server 200 stores the result of questionnaire in the questionnaire database 216, and relates it with information of a location. In the questionnaire result, customer satisfaction, unsatisfactory points, and information of contents desired to be added to the contents providing server 200 are stated. Further, the result of the questionnaire is referred by the user, when the user designates the contents in the contents providing server 200.

Moreover, in the above described embodiments, the user may transmit contents itself, for example, voice data from the microphone 314, to be designated to the contents providing server 200 from the user terminal 300, when the user designates the contents.

Moreover, in the contents replay system of the above described embodiments, the car navigation system 100 is used, but the present invention is not limited thereto, and as the car navigation system 100, any terminal may be used, provided that the terminal has the detection unit 153 and the communication unit 155 and can be moved with the movement of users of personal computers and portable information terminal and the like.

Moreover, in case the driver is a sales person, information about own schedules and the like are written and the like in a notebook, but in such a case, there may be a limit in space or important information may be omitted, and when he/she goes on sales visits to customer's company or on arrival at the customer's company, he/she may forget taking notes inadvance. According to the present invention, the car navigation system 100 replays the specified information registered in advance at specified place.

While this invention has been described in conjunction with the preferred embodiment described above, it will now be possible for those skilled in the art to put this invention into practice in various other manners.

What is claimed is:

1. A contents replay system comprising:
a registration unit which registers location information indicating a specific location and contents information indicating contents to be replayed at said specific location, designated by a user;
a detection unit which detects that said contents replay system is currently located at said specific location; and
a replay unit which replays said contents at said specific location detected by said detection unit.

2. A contents replay system comprising:
a network;
a terminal connected to said network, said terminal comprising,
a first communication unit which transmits contents information indicating contents to be replayed at a specific location to said network,
a detection unit which detects that said contents replay system is currently located at said specific location, and
a replay unit which replays contents indicated by said contents information at said specific location; and
a server connected to said network, said server comprising
a storing unit which stores said contents, and
a second communication unit which transmits said contents to said terminal via said network in response to a request of said terminal.

3. The contents replay system claimed in claim 2,
wherein said server transmits said contents to said terminal, before said detection unit detects said specific location.

4. The contents replay system claimed in claim 2,
wherein said server transmits said contents to said terminal, when said detection unit detects said specific location.

5. A contents replay system comprising:
a network;
a first terminal connected to said network, which comprises a first communication unit for transmitting location information indicating a specific location and contents information indicating contents to be replayed at said specific location to said network;
a server connected to said network, said server comprising,
a registration unit which registers said location information and said contents information transmitted from said first terminal,
a storing unit which stores said contents, and
a second communication unit which transmits said location information and said contents to said network;
a second terminal connected to said network, said second terminal comprising,
a third communication unit which receives said location information and said contents transmitted from said server via said network,
a detection unit which detects that said contents replay system is currently located at said specific location based on said location information, and
a replay unit which replays said contents at said specific location.

6. The contents replay system claimed in claim 5,
wherein said server transmits said contents to said second terminal, before said detection unit detects said specific location.

7. The contents replay system claimed in claim 5,
wherein said server transmits said contents to said second terminal, when said detection unit detects said specific location.

8. A contents replay system comprising:
a network;
a first terminal connected to said network, which comprises a registration unit for registering location information indicating a specific location and contents information indicating contents to be replayed at said specific location in a removable storage unit;
a server connected to said network, said server comprising,
a storing unit, which stores said contents, and
a first communication unit, which transmits said contents to said network;
a second terminal connected to said network, said server comprising,
a second communication unit which receives said contents transmitted from said server via said network,
a detection unit which detects that said contents replay system is currently located at said specific location based on said location information stored in said removable storage unit, and
a replay unit which replays said contents transmitted from said server via said network at said specific location.

9. The contents replay system claimed in claim 8,
wherein said server transmits said contents to said second terminal, when said detection unit detects said specific location.

10. A contents replay system comprising:
a network;
a server connected to said network, said server comprising,
a storing unit which stores contents, and
a first communication unit which transmits said contents to said network;
a first terminal connected to said network, said first terminal comprising,
a second communication unit which requests said server to transmit said contents and receives said contents from said server via said network,
a registration unit for registering location information indicating a specific location and said contents in a removable storage unit;
a second terminal connected to said network, said second terminal comprising,
a detection unit which detects that said contents replay system is currently located at said specific location based on said location information stored in said removable storage unit, and
a replay unit which replays said contents stored in said removable storage unit at said specific location.
